(19) United States
(12) Patent Application Publication
(10) Pub. No.: US 2006/0171667 A1
(43) Pub. Date: Aug. 3, 2006

(54) Real time recording system and method

(75) Inventors: Paul J. Murski, Georgetown, TX (US); David C. Bruce, Houston, TX (US)

Correspondence Address: LOCKE LIDDELL & SAPP LLP, 600 TRAVIS, 3400 CHASE TOWER, HOUSTON, TX, 77002-3095, US

(73) Assignee: David C. Bruce

(21) Appl. No.: 11/050,027

(22) Filed: Feb. 3, 2005

(51) Int. Cl. H04N 5/91

(52) U.S. Cl. 386/83

(57) ABSTRACT

The present disclosure provides a recording system and method that can record the video and audio portions of live performances in real time on removable digital media and provide such media at the end of the performance for distribution or purchase. The recording system directly records the video/audio on a plurality of independent digital recorders in real time to produce a plurality of original recordings in contrast to prior efforts which require pre-forming of tracks through a sequentially numbered mastering process for the digital media and then sending the mastered tracks to the digital media for recording, with the attendant time loss. The present disclosure, in contrast to prior efforts, can offer the recorded media within a few minutes of the end of the performance.

### FIELD

This disclosure relates to recording video and audio signals. More particularly, this disclosure relates to real time recording of video signals, audio signals, or a combination thereof from live performances.

### BACKGROUND

With high quality audio digital recording capabilities, the audio recording of live performances, such as concerts, has surged in popularity. Typically, one or more microphones transmit an analog audio signal to a mixer board to adjust the audio signal. The audio signal is then converted to a digital signal and then sent to an editing station. After further processing, the signal is parsed into subsections known as tracks and recorded onto a hard drive. As tracks of audio are received, edited, and processed, the one or more of the tracks of processed and digitized signals are sent to a media “burner” without further processing. The burner is only capable of imprinting processed data received from a computer or similar device that has already processed the information and provided it to the burner in a format such as an ISO format.

The processing takes time and has been unsuitable for producing recorded media, such as compact discs (CDs), for purchase immediately after live performances. For sales at live performance, the timing is crucial—concert attendees simply will not wait a lengthy time to fill an order, resulting in significant lost sales at the concert. Six-figure revenues can be generated at the live performances just on sales of recordings—if the recordings are quality and available in mass quantity immediately after the live performance. Thus, even small incremental reductions in the time to produce the recordings can be significant.

One example of recent technology for audio recording of live performances is found in U.S. Pat. No. 6,614,729. The document states that it provides an event recording system that has an event-capture module, an editing module, and a media recording module. The document states that it completes and produces a CD shortly after the live performance is completed. However, the document states and the claims require the process of editing (audio mastering) and parsing into digital track files for storage to a hard drive containing completed digital track files before affixing (typically known as “burning”) the data on the ultimate media (CDs) for distribution. Thus, this technology processes the signals into digital data and then sends the digital data to the CD recorders (“burners”). The data sent to the CD recorders can be either a completed track at a time or the entire set of tracks for a disk at a time, and so requires additional time.

While the document mentions the word “video”, the patent does not acknowledge the significant differences in video files compared to simply audio files. The video files can create an additional order(s) of magnitude increase in file sizes and processing time, and change the entire concept and applicability of that technology to meet the needs of video recording a live performance. Further, the current drives for video media such as Digital Versatile Disc (DVD) media, are capable of transfers speeds less than one-third that of CD burners. These facts combine to produce much longer record times for DVDs when compared with CDs. It is understood that using its teaching with current technology does not produce a combined video/audio recording in less than about one-half hour and more likely not less than forty-five minutes after the live performance—far too long to be of commercial value with the high loss of sales for that event.

Thus, there remains a need for an improved combined video and audio recording system and method that can directly record the performances in virtual real time to rapidly produce a recorded media for distribution at the live performance.

### SUMMARY

The present disclosure provides a recording system and method that can record the video and audio portions of live performances in real time on removable digital media and provide such media at the end of the performance for distribution or purchase. The recording system directly records the video/audio on a plurality of independent digital recorders in real time to produce a plurality of original recordings in contrast to prior efforts which require pre-forming of tracks through a sequentially numbered mastering process for the digital media and then sending the mastered tracks to the digital media for recording, with the attendant time loss. The present disclosure, in contrast to prior efforts, can offer the recorded media within a few minutes of the end of the performance.

The disclosure provides a system for recording on a plurality of removable digital media at a live performance and distributing the removable digital media at the live performance, comprising: at least one audio source adapted to produce at least one real time audio signal from the live performance; at least one video source adapted to produce at least one real time video signal from the live performance; and a recording unit, comprising an array of digital recorders, and a distribution module capable of receiving the at least one audio signal and the at least one video signal, wherein the distribution module is adapted to provide the at least one audio signal and the at least one video signal to the array such that a plurality of digital recorders in the array can record the at least one audio signal and the at least one video signal on the removable digital media.

The disclosure further provides a process for using a recording unit to record on removable digital media at a live performance and distributing the media at the live performance, comprising: receiving at least one real time video signal; receiving at least one real time audio signal; providing the at least one real time video signal and the at least one real time audio signal to a plurality of digital recorders; and independently recording the at least one real time video signal and the at least one real time audio signal onto a plurality of removable digital media using the digital recorders in the recording unit to produce a plurality of original recordings.

The disclosure also provides a system for recording on a plurality of removable digital media at a live performance and distributing the removable digital media at the live performance, comprising: at least one audio source adapted to produce at least one audio signal and at least one video source adapted to produce at least one video signal, at least one of the signals comprising a real time signal; and a recording unit, comprising an array of digital recorders, and a distribution module capable of receiving the at least one audio signal and the at least one video signal, wherein the distribution module is adapted to provide the at least one audio signal and the at least one video signal to the array such that a plurality of digital recorders in the array can record the at least one audio signal and the at least one video signal on the removable digital media to produce a plurality of original recordings.

### BRIEF DESCRIPTION OF DRAWINGS

FIG. 1 is an overall schematic of a real time recording system at a live performance.

FIG. 2 is a schematic flowchart of an exemplary recording system.

FIG. 3 is a top schematic view of an exemplary layout of the recording system.

FIG. 4 is a top schematic view of another exemplary layout of the recording system.

### DETAILED DESCRIPTION

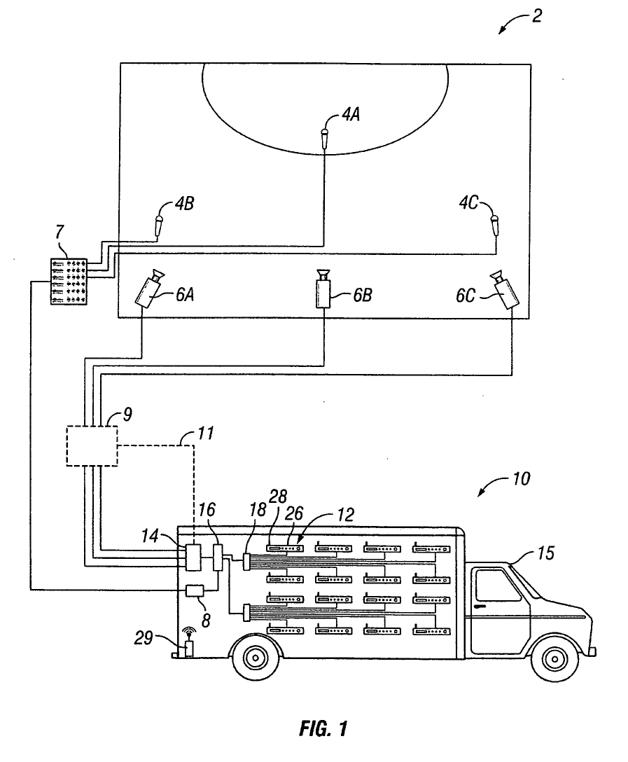

FIG. 1 is an overall schematic of a real time recording system at a live performance. The present disclosure generally includes a recording system 10 that can be coupled to various input feeds from a live performance 2 to record the live performance for rapid production and sale of recordable and removable digital media, such as DVDs, at the live performance. The recording system 10 generally includes a recording unit 15 that contains a recording system 12, including an array of digital recorders and associated equipment. In at least one embodiment, the recording unit 15 can include a mobile unit. The mobile unit can be without limitation a truck, semi-trailer, platform, or other structure that can generally house the digital recorders, other equipment, and recording media in a suitable environmentally appropriate structure and be transported from live performance to live performance. In other embodiments, the recording system can be a more fixedly positioned unit, such as fixedly stationed in a concert hall, auditorium, arena, and other structures in which the event is held.

In general, the recording system will use one or more real time audio signals with one or more real time video signals, a signal distribution module, and an array of digital recorders and associated equipment. The distribution module receives the real time audio signal and real time video signal and provides the video/audio signals to the array of digital recorders to record the video/audio signals on the removable digital media, such as DVDs, on each active recorder, so that a plurality of “original” recordings are recorded simultaneously. The digital recorders can each independently record the real time audio and real time video signals directly to the digital media. Independently recording with the digital recorders is intended to include the ability to record the live performance to each of the recorders as an original using the real time video and/or real time audio signal. This independent recording is in contrast to earlier efforts that required digital mastering track by track and storing onto a hard drive as a single original master and then sending the master to the disc burners to make duplicates. In earlier efforts, each burner simply burns a pre-mastered and processed signal. In at least one embodiment of the present disclosure, this independent real time recording is independent of, for example, a significant delay that typically would be needed to process, edit, and develop tracks and label tracks to create a mastered recorded program that is then fed as digital data to the disc burners, as in the prior efforts, resulting in lost time and delayed response. In other embodiments, the video and/or audio real time signal(s) can temporarily be delayed to adjust or otherwise process the video and/or audio signal(s), so that an adjusted video and/or audio real time signal(s), in contrast to processed data, can be sent to the digital recorders. Thus, “real time” signals are intended to include a signal generated at a live performance substantially contemporaneously with the live performance that is transmitted to a digital recorder.

The present disclosure advantageously can be used at a variety of live performances for producing recordings for purchase or other distribution quickly after the live performance is concluded. In general, the recordings can be produced within 15 minutes or less at the end of a live performance and in some embodiments in less than 10 minutes. The live performance can include, without limitation, concerts, plays, corporate ceremonies or lectures, public appearances of dignitaries, sporting events and other live events that have a visual and audio component that can be perceived by a human.

At the live performance 2, the performer will generally occupy a centrally placed position and an audience will at least partially surround the performer for audio and visual communication. One or more audio sources 4A, 4B, 4C, such as microphones, producing one or more real time audio signals, can be used as audio feed to the recording system 10. For example, a microphone can be used to record the performer, and other microphones can be used to record the audience response to produce a “live” feel to the recording.

In the embodiment shown, the audio signals are fed to a mixer 7, such as a soundboard or other device. The mixed audio signals can be obtained from the house or touring sound system that is also used to provide audio to the audience. The mixer typically is in close proximity to the live concert to allow the operator of the mixer to make adjustments to the audio program. However, in other embodiments, the mixer board could be provided remotely such as in the recording unit, described below.

Further, one or more video sources 6A, 6B, 6C producing one or more real time video signals can be provided. In at least one embodiment, the video sources can be cameras, such as professional camcorders of the DVcam or DVC pro formats presently used in broadcast news gathering. In some embodiments, multiple video signals can be used to generate multiple views, available for selection by an operator recording the live performance. Further, the multiple video signals can be recorded in multiple digital tracts to provide multiple angles for the viewer of the recording. The one or more video signals from the one or more video sources 6A, 6B, 6C can be provided directly to the recording system 10. In other embodiments, the video signals can be combined and mixed external to the recording system 10, such as with a switcher 9, to produce a video input 11 to the recording system 10. The mixed video signal could be obtained, for example, when the house or touring system includes a video system for output to house video screens for the audience's benefit during the live performance. The video signal could be routed in the recording unit similar to a pre-mixed audio signal from a mixer.

Once the signals are provided to the recording system 10, the video and audio signals can be selected, mixed, balanced and other processes as the signals stream through the equipment on the way to the digital recorders. For example, if the video sources 6A, 6B, 6C are each provided to the recording system 10, then a video switcher 14 can be used to perform transitions among the various sources as well as to fade to and from video black and other special effects as the signals pass through. Further, the video switcher 14 can be used to selectively choose which video signal is recorded into the video program at any particular time.

When a switcher is used, the output of the video switcher 14 generally provides the composite video program from the variety of video sources that can be recorded. In other embodiments, two or more video signals can be passed through the system to be recorded on the video, such as when a multi-angle video recording is to be made.

If the audio signal is pre-mixed through a mixer of the house or touring sound system, the audio feed can be provided to an audio compressor/limiter 8 to help ensure that the audio levels are consistent and that they are compatible with constraints of the recording equipment in use. Conversely, the audio signals could be provided as a direct feed without pre-mixing to the recording system 10 and recorded or mixed inside the recording system. Generally, the video and audio signals are generally not delayed for extensive processing and development of digital tracks prior to the recording as in prior efforts.

The real time audio signal and the real time video signal as the output of the switcher 14 can be sent to a signal distribution module 16. The signal distribution module 16 can include a multiplexer, splitter, and/or other associated equipment, such as amplifiers. For example, a multiplexer can produce a combined video/audio signal. The distribution module provides the audio and video signals to an array of recorders 26 as separate video and audio signals or as a combined signal. For illustrative purposes, FIG. 1 shows one line coupled to each digital recorder, but it is to be understood that the one line could represent either a combined signal or separate video and audio signals.

Intermediate to the array of recorders in some embodiments, one or more second level video/audio distribution modules 18, which can include amplifiers, can be used to further distribute the signals and enhance the signals to the various recorders to help ensure the quality of the signal.

The recorders are digital video/audio recorders adapted to record on digital removable media, such as DVDs, Secure Digital (SD), CompactFlash (CF), SmartMedia (SM), Memory Stick (MS), MultiMediaCard (MMC), xD-Picture Card (xD), and other portable memory digital memory media. In at least one embodiment, the recorders can be Panasonic Model T3030 for DVD recording. Further, the recording can be done concurrently on multiple formats of media by providing the signals to multiple types of media. The video and/or audio signals can be provided to the media through a physical connection, such as cabling or ports, or through wireless transmission. Because the recording is done essentially in real time to quickly produce a number of recorded media by the end of the live performance, a significant number of recorders will generally be used. In at least one embodiment, the recorders can number in excess of 100 recorders, and the number can exceed 700 recorders positioned in the recording unit.

One issue with the generally large number of recorders is synchronizing the recorders' operation. This is particularly an issue in that the recorders and the recording media are kept open and the absence of a video/audio feed for an extended period can yield to “coasters.” Coasters can yield unusable disks. Thus, synchronization and continuing feed is important. For example, if a pause were designed in the recording program, all recorders would desirably be stopped and restarted simultaneously. In at least one embodiment, the recorders can be synchronized by a communicator 28 that can receive signals from a recorder controller 29. The recorder controller without limitation can communicate via hardware or wireless communications.

It is envisioned that in general real time audio and real time video signals will be used. In some embodiments one signal (audio or video) can be prerecorded and provided with a real time signal to the recording system to be recorded onto the removable media to produce the plurality of original recordings. For example, a real time video signal with a prerecorded audio signal can be used for events where the audio can be less important than the video during at least portions of the event, such as a motor cross race or other events. Further, certain portions of a given recording can have real time audio and video signals and other portions can have a mixture of real time and prerecorded signals.

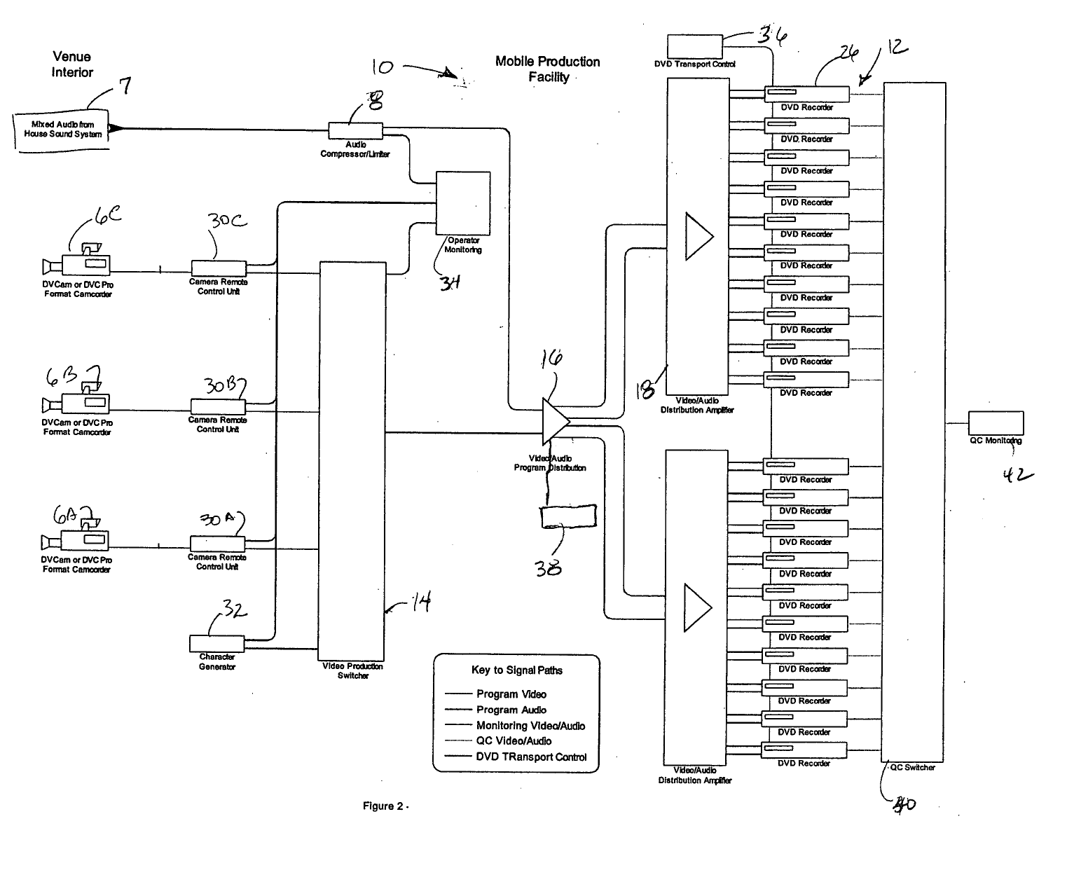

FIG. 2 is a schematic flowchart of an exemplary recording system. Similar elements are similarly numbered as in FIG. 1. An audio signal mixed from a mixer 7, such as a soundboard, is provided to the recording system 10. The audio signal can be routed through an audio compressor/limiter 8 to ensure that audio levels are consistent and compatible with the recording equipment. The audio signals can proceed to the individual recorders, separately from a video signal, or in a combined form such as through a multiplexer. Further, the signal can be assisted in some embodiments through an amplifier.

Similarly, one or more video signals can be provided from one or more video sources 6A, 6B and 6C. One or more of the video sources can be controlled with one or more remote control units 30A, 30B, 30C. The control units permit an operator control over the camera parameters to allow different variations in the video program. Output from the video sources can be routed through a video switcher 14. The video switcher 14 can provide the ability to perform transitions and combination among the various video sources as well as to fade to and from video black and other possible variations. The output of the switcher generally provides the program that can be recorded.

The output of the video switcher is generally coupled to a signal distribution module 16. As described above, the distribution module can be a multiplexer, splitter, and/or other associated equipment that can send the audio signal and video signal (separate from each other or combined) to an array of digital recorders 26 for recording the signals to produce a plurality of original recordings. In at least one embodiment, the signals will be real time audio and real time video. It can be advantageous to include one or more distribution amplifiers 18, such as in the distribution module 16 or as a separate piece of equipment, to boost the signal for proper recording on the array of recorders.

An operator can monitor the audio and/or video signals at monitor 34. The recording system can further include a transport control 36. The transport control 36 can control the transport of the removable media such as DVDs to and from the recorders. The recording system 10 can further include a quality control station to periodically monitor the recording quality on the media. For example, the recorders output could be coupled to a quality control switcher 40 which in turn can be coupled to a quality control monitor 42. The quality control switcher can selectively choose a recorder to receive an output of the media to determine the quality and then choose other subsequent recorders for similar determinations.

The recording system 10 can further include an optional digital media encoder/recorder or video tape recorder to record the real time video and/or audio signal as a permanent recording of the live performance for subsequent processing and distribution of later recorded media, should the event merit such recording. The system can further include a character generator 32. The character generator can produce electronic fonts for input to the video/audio signal and recording thereof.

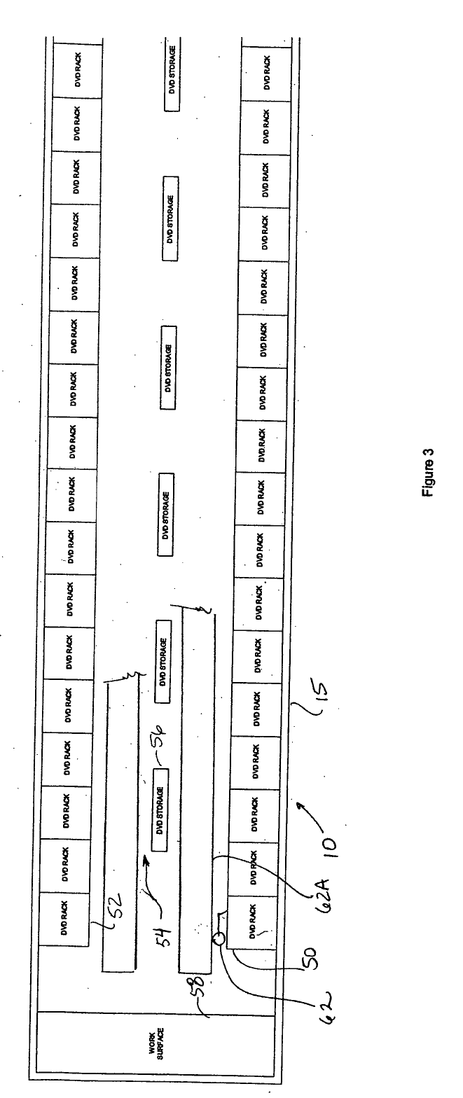

FIG. 3 is a top schematic view of an exemplary layout of the recording system 10. The recording system 10 includes the recording unit 15, described above. The equipment generally has been described above. The unusually large numbers of digital recorders that are advantageously used to produce the real time recordings require significant storage areas and access. One exemplary layout is shown in FIG. 3. The recording unit can include a series of racks to support the digital recorders. The racks can be configured to be adjacent perimeter surfaces of the recording unit 15. For example, a first series of racks 50 can be supported on one side of the recording unit and a second series of racks 52 can be supported on an opposite side of the recording unit. A service aisle 54 is formed therebetween. It can be advantageous to form one or more digital media storage areas 56 for access to digital media for insertion into the digital recorders.

Auto-changers 62 can be used to load and unload digital recorders. For example, the auto-changers can include robotic or mechanical arms or other material handlers to perform one or more functions of retrieving a recordable digital media, inserting the media into the digital recorder, and extracting the media from the digital recorder. Further, the term “auto-changers” can include associated equipment, such as one or more conveyors 62A and other material handling equipment, to provide the recordable digital media to the digital recorders and/or provide the digital media after recording to an outlet for the digital media. For example, the outlet could be a sales counter at the live performance.

In at least one embodiment, the use of 19-inch wide EIA standard equipment racks with 44 rack units measures about 77 inches of available vertical space. If a height of two rack units (3.5 inches) per recorder is used, each three-rack unit would support 56 recorders. If the racks are configured for use on one side of the rack as shown using 20-inch deep racks, the total support for this configuration is about 800 recorders in a typical semi-trailer sized recording unit.

It can be further advantageous to have one or more work surfaces 58 in the recording unit 15. The work surface can be used among other things for packaging, sorting, sales, and other functions associated with the production and marketing of the live performance recordings.

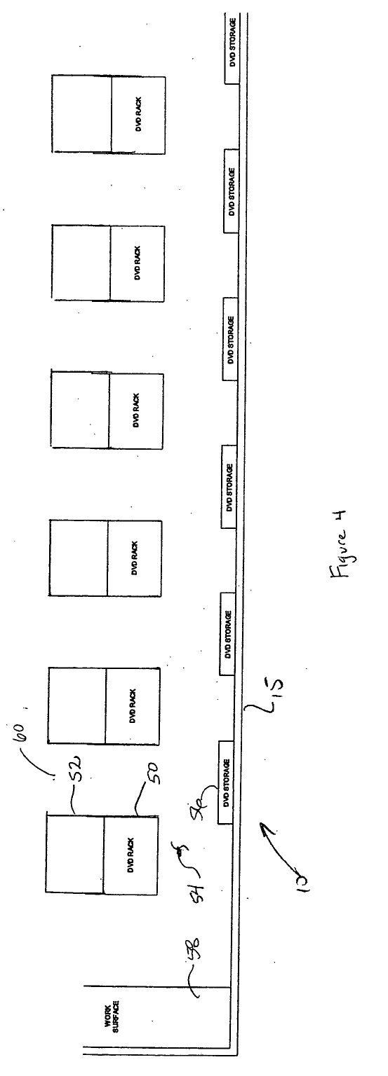

FIG. 4 is a top schematic view of another exemplary layout of the recording system 10. Similar to the layout in FIG. 3, the recording unit 15 generally includes racks for storage of digital recorders, media storage, and one or more work surfaces. In this embodiment, the racks are disposed back to back toward a middle of the recording unit 15, leaving aisles nearer to the sides of the recording unit. For example, one set of racks 50 can be disposed back to back with a second set of racks 52. The back-to-back orientation can leave one or more service aisles 54 adjacent to the sides of the recording unit 15. Further, one or more digital media storage areas 56 can be placed adjacent to the side of the recording unit 15 for convenience and accessibility to the racks. Similarly, a work surface 58 can be included into the recording unit 15. Depending upon the density of the rack system, one or more aisles 60 can be disposed between adjacent racks systems. Alternatively, the aisles 60 can be occupied with other racks to increase the density of the recorders in the recording unit 15.

In operation, the promoter of a live performance and the owner of the recording system 10 generally will contract to record the performance and delineate associated rights to the media and copyrights. Prior to live performance, an itinerary of the live performance, such as a song list or outline, can be provided to the personnel working with the recording system 10. In some embodiments, a label can be preprinted and affixed to the media, various packaging particular to the event prearranged, and other preparatory measures taken to enhance the quality and marketability of the end product of the live performance. Further, the contract can include predetermined pauses, encores, and other choreographed events to allow for preplanning of the live performance recording. Further, prearrangements of backstage recording, background materials related to the performances, sponsorships (such as national, state, and local), history clips of performers and performances, audience images, information on ordering additional recorded media, interviews of fans and performers, general and specific disclaimers, and other items of interest can be prearranged, pre-recorded, or otherwise offered with the live performance recording.

Prior to the event, the recording unit can be located onsite and connected to the various inputs of the house or touring system that can accompany the live performance artists. If video sources particular to the real time recording system are being used, then those sources are set up at the appropriate locations and angles. Similarly, the audio sources can be set up at particular locations, if the real time recording system is responsible for such audio input. The removable digital media upon which the live performance is recorded is loaded into the recorders in the recording system and the recording is synchronized with the plurality of recorders at an appropriate time, such as when the live performance begins.

At the beginning of the live performance, recorders in the array that are in working order and otherwise presently capable of receiving and recording the signals onto the digital media can be actuated to independently receive the real time video and/or audio signals, either separate from each other or as a combined signal. The recording system generally receives at least one real time video signal and at least one real time audio signal. The disclosure generally refers to real time audio and real time video signals as an advantageous embodiment. However, it is to be understood that in some embodiments, the recording system can receive at least one real time signal for video or audio and a prerecorded signal for the remaining signal to produce a real time recording of the event with at least one real time signal. Thus, the recording system 10 that can be used for embodiments having both real time audio and video signals are understood herein to be able to be adapted to receive at least one real time signal and at least one prerecorded signal, and are limited only by the claims. Further, the digital recorders can each independently record the audio and video signals directly to the digital media to produce a plurality of original recordings.

If a significant pause in the performance occurs, the recorders can be stopped momentarily in synchronized time and restarted when appropriate. At the conclusion of the event, a brief period of time is generally used for “finalization” of the recordings to ensure compatibility with a wide variety of digital players. The recordings are then available for virtually immediate distribution.

While the foregoing is directed to various embodiments of the present invention, other and further embodiments may be devised without departing from the basic scope thereof. Other embodiments within the scope of the claims herein will be apparent to one skilled in the art from consideration of the specification and practice of the invention as disclosed herein. For example, some pre-mixing and processing equipment can be located on site and other equipment can be included with the recording unit. Other layouts of the recording unit and associated recorders are possible. It is intended that the specification, together with the example, be considered exemplary only, with the scope and spirit of the invention being indicated by the claims which follow.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described or shown herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

1. A system for recording on a plurality of removable digital media at a live performance and distributing the removable digital media at the live performance, comprising:
a. at least one audio source adapted to produce at least one real time audio signal from the live performance;
b. at least one video source adapted to produce at least one real time video signal from the live performance; and
c. a recording unit, comprising:
i) an array of digital recorders; and
ii) a distribution module capable of receiving the at least one audio signal and the at least one video signal, wherein the distribution module is adapted to provide the at least one audio signal and the at least one video signal to the array such that a plurality of digital recorders in the array can record the at least one audio signal and the at least one video signal on the removable digital media.

2. The system of claim 1, wherein the recording unit comprises a mobile unit.

3. The system of claim 1, wherein the system is adapted to produce a plurality of the removable digital media within fifteen minutes of the end of the live performance.

4. The system of claim 1, wherein the recording unit is adapted to produce a plurality of simultaneous original recordings from the at least one audio signal and the at least one video signal.

5. The system of claim 1, further comprising a multiplexer electronically coupled to the digital recorders.

6. The system of claim 1, further comprising a switcher electronically coupled to the distribution module and adapted to select an audio signal, a video signal, or a combination thereof from a plurality of signals provided to the switcher.

7. The system of claim 1, wherein the recording unit comprises at least one hundred digital recorders adapted to accept the at least one audio signal and the at least one video signal for independent recording on removable digital media.

8. The system of claim 1, wherein the digital recorders receive a prerecorded signal for a portion of the recording on the digital media.

9. The system of claim 1, further comprising a rack system adapted to support the digital recorders in the recording unit.

10. The system of claim 1, further comprising at least one auto-changer adapted to load and unload the removable digital media from the digital recorders.

11. The system of claim 1, further comprising a loading station coupled to the recording unit, adapted to package the removable digital media into packages.

12. The system of claim 1, wherein the removable digital media comprises a Digital Versatile Disc (DVD) media.

13. A process for using a recording unit to record on removable digital media at a live performance and distributing the media at the live performance, comprising:
a. receiving at least one real time video signal;
b. receiving at least one real time audio signal;
c. providing the at least one real time video signal and the at least one real time audio signal to a plurality of digital recorders; and
d. independently recording the at least one real time video signal and the at least one real time audio signal onto a plurality of removable digital media using the digital recorders in the recording unit to produce a plurality of original recordings.

14. The process of claim 13, further comprising producing a plurality of recorded removable digital media within fifteen minutes of the end of the live performance.

15. The process of claim 13, further comprising selecting at least one real time video signal and at least one real time audio signal from a plurality of signals to provide to the digital recorders.

16. The process of claim 13, wherein independently recording occurs on at least the one hundred digital recorders in the recording unit to produce the plurality of original recordings on the removable digital media.

17. The process of claim 13, further comprising distributing the real time video signal and the real time audio signal into a plurality of real time video and audio signals and synchronizing recording on the digital recorders of the real time video and audio signals.

18. The process of claim 13, further comprising:
a) selecting a plurality of real time video signals;
b) selecting a plurality of real time audio signals;
c) providing the plurality of real time video signals and the plurality of real time audio signals to the digital recorders; and
d) recording the plurality of real time video signals and the plurality of real time audio signals on the removable digital media.

19. The process of claim 13, further comprising altering at least one real time video signal or altering at least one real time audio signal provided to the recorders.

20. A system for recording on a plurality of removable digital media at a live performance and distributing the removable digital media at the live performance, comprising:
a. at least one audio source adapted to produce at least one audio signal and at least one video source adapted to produce at least one video signal, at least one of the signals comprising a real time signal; and
b. a recording unit, comprising:
i) an array of digital recorders; and
ii) a distribution module capable of receiving the at least one audio signal and the at least one video signal, wherein the distribution module is adapted to provide the at least one audio signal and the at least one video signal to the array such that a plurality of digital recorders in the array can record the at least one audio signal and the at least one video signal on the removable digital media to produce a plurality of original recordings.

21. The system of claim 20, wherein the video signal comprises a real time video signal and at least a portion of the audio signal comprises a prerecorded audio signal.

22. The system of claim 20, wherein at least a portion of each of the video signal and the audio signal are real time signals from the live performance.
